(19) United States
(12) Patent Application Publication
(10) Pub. No.: US 2022/0253565 A1
(43) Pub. Date: Aug. 11, 2022

(54) TERMINAL ANTI-TAMPER DETECTION METHOD AND APPARATUS

(71) Applicant: FEITIAN TECHNOLOGIES CO., LTD., Beijing (CN)

(72) Inventors: Zhou Lu, Beijing (CN); Huazhang Yu, Beijing (CN)

(21) Appl. No.: 17/611,438

(22) PCT Filed: Sep. 3, 2020
(86) PCT No.: PCT/CN2020/113295

§ 371 Date: Nov. 15, 2021

(30) Foreign Application Priority Data
Oct. 29, 2019 (CN) 201911038209.6

(51) Int. Cl. G06F 21/86; G06F 7/58

(52) U.S. Cl. CPC G06F 21/86; G06F 7/588

(57) ABSTRACT

A terminal anti-tamper detection method and an apparatus, in the field of information security. The method comprises: a security processing system generating a dynamic signal, outputting the dynamic signal via a self-destruct line output terminal, and receiving a signal via a self-destruct line input terminal (Step S1); the security processing system performing comparison of the signal received via the self-destruct line input terminal and the dynamic signal output via the self-destruct line output terminal, obtaining a comparison result (Step S2); the security processing system determining whether the comparison result meets a self-destruct trigger condition, the self-destruct line being triggered if so, and if not, the self-destruct line not being triggered (Step S3). The present method, by means of using dynamic MESH line anti-tamper technology, can accurately detect a triggering situation, making sure that a protected product immediately acts when unauthorized tampering occurs, ensuring that sensitive information of an individual is not leaked.

### FIELD OF THE INVENTION

The present invention relates to a method for detecting a terminal for protecting it from being dismantled (or called anti-dismantling) and a device therefor, which belong to information security technical field.

### PRIOR ART

With progress of science and development of intelligent technology, more and more electric product includes all kinds of sensitive information, for example, POS machine of financial industry, smart lock of door of smart home industry and other electric device stored with sensitive information. At present, protecting electric device mainly adapts simple physical protection, for example, setting static parameters or protecting sensitive information incompletely, which results in obtaining sensitive information with low cost, leads to leaking of personal sensitive information and causes personal lost. Therefore, how to protect those sensitive data from being intercepted or using illegally became a problem sought to be solved urgently.

### SUMMARY OF THE INVENTION

One object of the present invention is to provide a method for detecting a terminal for protecting it from being dismantled and a device therefor, making sure that a protected product can destroy its sensitive information when it faces external and illegal removal or attacking, therefore personal sensitive information cannot be leaked.

Another object of the present invention is to provide a method for detecting a terminal for protecting it from being dismantled and a device therefor, being additionally provided with an anti-dismantle detecting function which is with chip shield level on temperature and/or voltage, therefore personal sensitive information cannot be leaked.

Therefore, according to one aspect of the present invention, there is provide a method for detecting a terminal for protecting it from being dismantled, in which the terminal includes a secure processing system, the secure processing system includes a self-damage wire input port and a self-damage wire output port, the method includes:

Step S1, a security processing system generates a dynamic signal, outputs the dynamic signal via the self-damage wire output port and receives signal via the self-damage wire input port;

Step S2, the security processing system compares the signal received by the self-damage wire input port with the dynamic signal output by the self-damage wire output port and obtains a comparing result; and

Step S3, the security processing system determines whether the comparing result meets a self-damage triggering condition, if yes, self-damage wire is triggered; if no, self-damage wire is not triggered.

According to another aspect of the present invention, there is provided a terminal anti-dismantle detecting device, which includes a security processing module, the security processing module includes a self-damage wire output port and self-damage wire output port;

the security processing module is configured to generate a dynamic signal, output dynamic signal via the self-damage wire output port, receive signal via the self-damage wire input port; compare the signal received by the self-damage wire input port and the dynamic signal output by the self-damage wire output port and obtain a comparing result; determine whether the comparing result meets a self-damage wire triggering condition, if yes, determine that the self-damage wire is triggered; otherwise, determine that the self-damage wire is not triggered.

According to the present invention, the method or device for detecting a terminal for protecting it from being dismantled adapts anti-dismantle technology of dynamic MESH wire, sets the optimum dynamic MESH wire parameter, which can accurately detect triggering status and makes sure that sensitive information is destroyed immediately when a protected product is illegally dismantled or attacked from outside and makes a further treatment in time; in addition, to monitor any dismantling includes detecting temperature, voltage and chip level shield which guarantees that personal information will not be leaked.

### BRIEF DESCRIPTION OF THE DRAWINGS

FIG. 1 is a flowchart of a method for detecting a terminal for protecting it from being dismantled provided by Embodiment 1 of the present invention;

FIG. 2 is a diagram of a first specific implementing way in a detecting method for anti-dismantling terminal provided by Embodiment 2 of the present invention;

FIG. 3 is a diagram of a second specific implementing way in a detecting method for anti-dismantling terminal provided by Embodiment 3 of the present invention; and

FIG. 4 is a flow chart of a detecting method for anti-dismantling terminal provided by Embodiment 4 of the present invention.

### DESCRIPTION OF PREFERRED EMBODIMENTS

The technical solutions of the embodiments of the present disclosure are described clearly and completely in conjunction with the accompanying drawings in the below. Apparently, the described embodiments are merely part but not all of the embodiments of the present disclosure. Based on the described embodiments of the present disclosure, other embodiments obtained by those skilled in the art without any creative work will fall within the claimed scope of protection.

### Embodiment 1

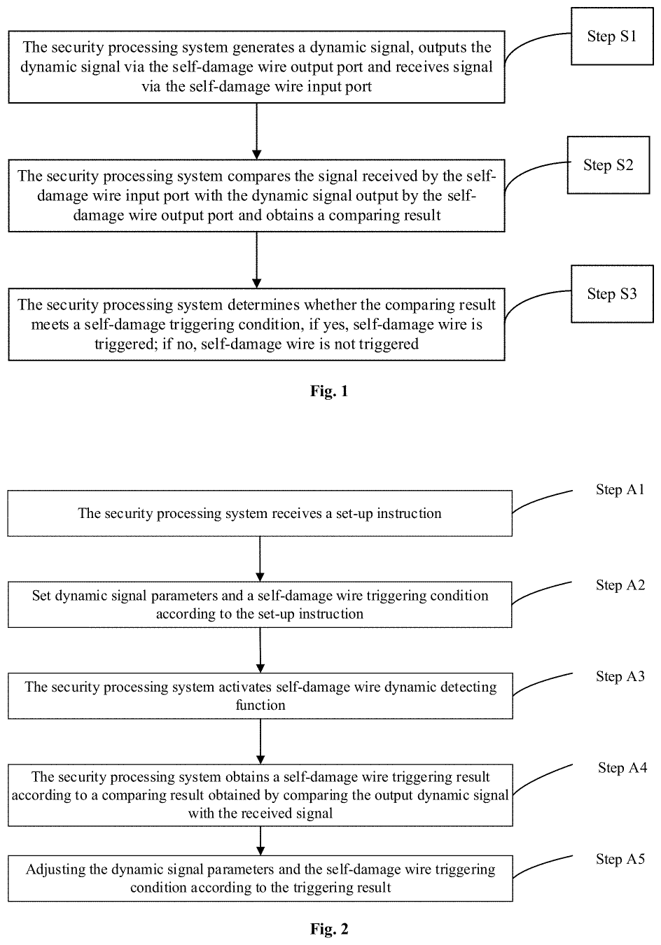

Embodiment 1 of the present invention provides a method for detecting a terminal for protecting it from being dismantled, wherein the terminal comprises a security processing system and the security processing system comprises a self-damage wire input port and a self-damage wire output port, the self-damage wire input port and the self-damage wire output port via a self-damage wire; as shown by FIG. 1, the method includes the following steps:

Step S1, the security processing system generates a dynamic signal, outputs the dynamic signal via the self-damage wire output port and receives signal via the self-damage wire input port;

Step S2, the security processing system compares the signal received by the self-damage wire input port with the dynamic signal output by the self-damage wire output port and obtains a comparing result; and

Step S3, the security processing system determines whether the comparing result meets a self-damage triggering condition, if yes, self-damage wire is triggered; if no, self-damage wire is not triggered.

Preferably, the security processing system includes a first security chip, the self-damage wire output port and the self-damage wire input port are located in the first security chip; the method specifically comprises:

the first security chip generates dynamic signal, outputs the generated dynamic signal via the self-damage wire output port and receives signal via the self-damage wire input port;

the first security chip compares the output dynamic signal with the received signal and obtains a comparing result; and

the first security chip determines whether the comparing result meets a triggering condition, if yes, self-damage wire is triggered; if no, self-damage wire is not triggered.

Preferably, the security processing system comprises a first master control chip and a second security chip; the method specifically comprises:

the first master control chip generates the dynamic signal and sends the generated dynamic signal to the second security chip; the second security chip outputs the dynamic signal via the self-damage wire output port, receiving, by the second security chip, the signal via the self-damage wire input port;

the second security chip compares the output dynamic signal and the received signal and obtains a comparing result;

the second security chip determines whether the comparing result meets a triggering condition, if yes, self-damage wire is triggered; if no, self-damage wire is not triggered.

Preferably, the security processing system includes a third security chip and a fourth security chip, the self-damage wire output port is located on a third security chip and the self-damage wire input port is located on a fourth security chip.

In Embodiment 1, the security processing system generates a dynamic signal, outputs the dynamic signal via the self-damage wire output port and receives signal via the self-damage wire input port specifically is: that the third security chip generates a dynamic signal, outputs the dynamic signal via the self-damage wire output port and the fourth security chip receives signal via the self-damage wire input port.

That the security processing system compares the signal received by the self-damage wire input port with the dynamic signal output by the self-damage wire output port specifically is: that the fourth security chip sends the received signal to the third security chip, then the third security chip compares the output dynamic signal and the received signal.

In Embodiment 1, after the third security chip generates a dynamic signal, the method further includes that the third security chip sends the dynamic signal to the fourth security chip.

That the security processing system compares signal received by the self-damage wire input port and the dynamic signal output by the self-damage wire output port specifically is that the fourth security chip compares the received dynamic signal and the signal received by the self-damage wire input port.

Preferably, the security processing system generates a dynamic signal, outputs the dynamic signal via the self-damage wire output port and receives signal via the self-damage wire input port specifically is that

the third security chip generates dynamic signal, converts the dynamic signal and outputs the converted signal via the self-damage wire output port; the fourth security chip receives the signal via the self-damage wire input port.

Specifically, after the third security chip generates the dynamic signal, the method further includes that the third security chip sends the dynamic signal and a converting algorithm to the fourth security chip.

The security processing system compares the signal received by the self-damage wire output port and the dynamic signal output by the self-damage wire output port specifically is that

the fourth security chip converts the dynamic signal received according to the converting algorithm to obtain the converted signal and compares the signal received by the self-damage wire input port and the converted signal.

Preferably, the security processing system includes a second master control chip, a fifth security chip and a sixth security chip; the self-damage wire output port is located on the fifth security chip, the self-damage wire input port is located on the sixth security chip.

In Embodiment 1, that the security processing system generates a dynamic signal, outputs the dynamic signal via the self-damage wire output port and receives signal via the self-damage wire input port specifically is:

the second master control chip generates a dynamic signal, sends the dynamic signal to the fifth security chip, the fifth security chip outputs the dynamic signal via the self-damage wire output port; the sixth security chip receives signal via the self-damage wire input port.

In embodiment 1, the security processing system compares the signal received by the self-damage wire input port and the dynamic signal output by the self-damage wire output port specifically is that the sixth security chip sends the received signal to the second master control chip, the second master control chip compares the received signal and the generated dynamic signal.

Preferably, after the second master control chip generates the dynamic signal, the method further includes sending the dynamic signal to the sixth security chip.

That the security processing system compares the signal received by the self-damage wire input port with the dynamic signal output by the self-damage wire output port specifically is that the sixth security chip compares the received dynamic signal with the signal received by the self-damage wire input port.

Specifically, that the security processing system generates dynamic signal, outputs the dynamic signal via the self-damage wire output port and receives the signal via the self-damage wire input port specifically is that

the second master control chip generates dynamic signal, converts the dynamic signal and sends the converted dynamic signal to the fifth security chip; the fifth security chip outputs the converted dynamic signal via the self-damage wire output port; the sixth security chip receives signal via the self-damage wire input port.

Specifically, the security processing system compares the signal received by the self-damage wire input port with the dynamic signal output by the self-damage wire output port specifically is that the sixth security chip sends the received signal to the second master control chip, the second master control chip compares the received signal with the converted dynamic signal.

Preferably, after the second master control chip generates dynamic signal, the method further includes sending the dynamic signal and the converting algorithm to the sixth security chip.

That the security processing system compares the signal received by the self-damage wire input port and the dynamic signal output by the self-damage wire output port specifically is that the sixth security chip converts the received dynamic signal according to the converting algorithm and compares the signal received by the self-damage wire input port with the converted signal.

In Embodiment 1, the security processing system outputs the dynamic signal via the self-damage wire output port specifically is that outputting the dynamic signal via the self-damage wire output port according to a preset output work frequency.

That the security processing system receives the signal via the self-damage input port specifically is sampling the received signal received by the self-damage wire input port according to the preset output work frequency to obtain a plurality of sampling values.

In Embodiment 1, after the self-damage wire is triggered, the method further includes that the security processing system clears sensitive information.

In Embodiment 1, the security processing system can further include a plurality of self-damage wire input ports and a plurality of self-damage output ports; the plurality of self-damage wire input ports and the plurality of self-damage output ports are connected via self-damage wire.

### Embodiment 2

Based on Embodiment 1, Embodiment 2 provides a specific embodiment of a detecting method for anti-dismantling terminal, the terminal includes a security processing system; the security system includes a self-damage wire input port and a self-damage wire output port; the input port and the output port are connected via a self-damage wire; In this case, as shown by FIG. 2, the specific embodiment discloses that before the security processing system generates dynamic signal, the method further includes:

Step A1, the security processing system receives a set-up instruction.

In Embodiment 2, Step A1 specifically includes: the security processing system waiting for an upper host to issue an instruction, analyzes the instruction issued by the upper computer, determines a type of the instruction; when the type of instruction is set-up instruction, executes Step A2.

Step A2, set dynamic signal parameters and a self-damage wire triggering condition according to the set-up instruction.

In Embodiment 2, specifically, the dynamic signal parameters include: output frequency, sampling frequency; the self-damage wire triggering condition includes: a count value of error filtering.

In one aspect, the security processing system outputs dynamic signal via self-damage wire output port, receives signal via the self-damage wire input port specifically is that the security processing system outputs dynamic signal via the self-damage wire output port according to the dynamic signal parameters, receives signal via the self-damage wire input port according to the dynamic signal parameters.

Preferably, the security processing system outputs dynamic signal via the self-damage wire output port according to the dynamic signal parameter, receives signal via the self-damage wire input port according to the dynamic signal parameters specifically is that the security processing system outputs dynamic signal via the self-damage wire output port according to the output frequency and receives signal via the self-damage wire input port according to the sampling frequency.

That the security processing system compares the signal received via the self-damage wire input port with the dynamic signal output by the self-damage wire output port and obtains a comparing result specifically is that the security processing system samples the signal received by the self-damage wire input port according to a preset input sampling frequency to obtain a plurality of sampling values, compares the plurality sampling values with a value of the output dynamic signal and obtains times of error sampling value.

That the security processing system determines whether a comparing result meets a self-damage wire triggering condition specifically is that the security process system determines whether the times of error sampling value is more than the count value of error filtering; when the times of error sampling value is more than the count value of error filtering, the self-damage wire triggering condition is meet; when the times of error sampling value is less than or equal to the count value of error filtering, the self-damage wire triggering condition is not meet.

In Embodiment 2, the security processing system sets a self-damage wire output frequency, a self-damage wire input sampling frequency and the self-damage wire triggering condition specifically is that the security processing system sets the self-damage wire output frequency as a first preset value, obtains a self-damage wire output sampling frequency by computing according to the first preset value and a preset clock frequency division factor, obtains a self-damage wire output work frequency according to the self-damage wire output sampling frequency and the preset clock frequency division factor and obtains the count value of error filtering according to the self-damage wire output sampling frequency and the self-damage wire output work frequency.

Specifically, the security processing system sets dynamic signal parameters specifically is:

setting the self-damage wire input sampling frequency F_in as 8 KHz;

dividing the self-damage wire input sampling frequency F_in by the clock frequency division factor D to obtain the self-damage wire output sampling frequency F_sample;

dividing the self-damage wire sampling frequency F_sample by the output division factor F to obtain the self-damage wire output work frequency F_out;

dividing the self-damage output sampling frequency F_sample by the self-damage wire output sampling frequency F_out to obtain a result and deducting 1 from the result to obtain a number and taking the number as cardinal number, taking an number which is less than the cardinal number as the count value of error filtering Cnt.

Preferably, the clock frequency division factor and the output division factor can be set to be a minimum value, the count value of error filter can be set as 0.

For example, the input sampling frequency F_in=8 KHz;

the self-damage wire output sampling frequency F_sample=F_in/D=8/D, D is the clock frequency division factor;

the self-damage wire output work frequency F_out=F_sample/F, F is output division factor;

the count value of error filtering Cnt<F_sample/F_out−1, Cnt=0, 1, . . . .

Step A3, the security processing system activates self-damage wire dynamic detecting function.

In Embodiment 2, after activating the self-damage wire dynamic detecting function, the security processing system executes detecting method.

Step A4, the security processing system obtains a self-damage wire triggering result according to a comparing result obtained by comparing the output dynamic signal with the received signal.

In Embodiment 2, that the security processing system obtains a self-damage wire triggering result according to a comparing result obtained by comparing the output dynamic signal with the received signal specifically is that the security processing system obtains the self-damage wire triggering result according to the count value of error filtering.

That the security processing system obtains the self-damage wire triggering result according to the count value of error filtering specifically is: when the count value of error filtering meets the triggering condition, the self-damage wire triggering result is that the self-damage wire is triggered; when count value of error filtering does not meet the triggering condition, the self-damage wire triggering result is that the self-damage wire is not triggered.

Step A5, Adjusting the dynamic signal parameters and the self-damage wire triggering condition according to the triggering result.

Specifically, in Embodiment 2, adjusting the dynamic signal parameters and the self-damage wire triggering condition according to the triggering result specifically is adjusting the output frequency, the sampling frequency and the count value of error filtering.

Preferably, in one aspect, when the triggering result is that the self-damage wire is triggered, adjusting the dynamic signal parameters and the count value of filtering according to the triggering result specifically includes:

Step M1, the security processing system modifies the preset count value of error filtering according to a preset pattern, determines whether the modified count value of error filtering is qualified, if yes, execute Step M2; otherwise, execute Step M3.

Preferably, the first preset pattern set by the security processing system is increment pattern, the security processing system sets the count value of error filtering to be 0, sets the clock frequency division factor and the output division factor to be a minimum threshold value.

That the security processing system modifies the preset count value of error filtering according to a preset pattern specifically is that the security processing system obtains a preset count value of error filtering, adds 1 to the preset count value of error filtering and obtains a new count value of error filtering.

Preferably, determining whether the modified count value of error filtering is qualified is that the security processing system divides the self-damage wire output sampling frequency by the self-damage wire output work frequency to obtain a result, deducts 1 from the result to obtain a number and takes the number as cardinal number, when the modified count value of error filtering is more than or equal to the cardinal number, the modified count value of error filtering is not qualified; when the modified count value of error filtering is less than the cardinal number, the modified count value of error filtering is qualified.

Step M2, detecting whether the self-damage wire is triggered, when the self-damage wire is triggered, execute Step M1, otherwise, returning a message that the self-damage wire is not triggered.

Specifically, returning a message that the self-damage wire is not triggered is returning a message that the self-damage wire is not triggered to the upper host.

Step M3, the security processing system determines whether the clock frequency division factor is more than or equal to a first threshold value, if yes, execute Step M4; otherwise, adjusts the clock frequency division factor and the count value of error filtering according to a second preset pattern, execute Step M2.

Preferably, adjusting the clock frequency division factor and the count value of error filtering specifically is that the security processing system obtains an original clock frequency division factor, adds 1 to the original clock frequency division factor and obtains a new clock frequency factor, sets the count value of the error filter to be 0.

Step M4, the security processing system determines whether the output division frequency factor is more than or equal to a second threshold value, if yes, return an error message to the upper host; otherwise, adjust the output division frequency factor, the clock division frequency factor and the count value of error filtering according to a third preset pattern, execute Step M2.

Preferably, adjusting the output division frequency factor, the clock division frequency factor and the count value of error filtering according to a third preset pattern specifically is that the security processing system obtains an original output division factor, adds 1 to the original output division factor to obtain a new output division factor, sets the clock division factor to be a minimum value and sets the count value of error filtering to be 0.

Specifically, when the self-damage wire is not triggered, Step M2 specifically includes that the security processing system takes values of current adjusted parameters as preset values of the parameters, sets an anti-dismantle security setting identification and activates anti-dismantle and anti-detecting status.

Preferably, in another aspect, when the self-damage wire triggering result is that the anti-damage wire is not triggered, adjusting dynamic signal parameters and triggering condition specifically includes:

Step N1, the security processing system modifies output division frequency factor according to a fourth preset pattern, determines whether the modified output division frequency is less than the maximum threshold and more than a minimum threshold, if yes, execute Step N2, otherwise, execute Step N3.

Preferably, the security processing system sets the fourth preset pattern as decrement pattern, the security processing system sets the count value of error filtering as cardinal number, sets the clock division frequency factor and the output division frequency factor as a maximum threshold.

That the security processing system modifies the output division frequency factor according to the fourth preset pattern specifically is that the security processing system obtain a preset output division frequency factor, minus 1 from the preset output division frequency factor and obtains a new output division frequency factor.

Preferably, determining whether the modified output division frequency factor is qualified specifically is that the security processing system determines whether the output division frequency factor is less than the maximum threshold value and more than the minimum threshold value, if yes, the modified output division frequency factor is qualified; otherwise, the modified output division frequency factor is not qualified.

Step N2, detects whether the self-damage wire is triggered, when the self-damage wire is triggered, return a message that the self-damage wire is trigger; otherwise, execute Step N1.

Step N3, the security processing system determines whether the clock division frequency factor is less than or equal to the maximum value and more than the minimum threshold value, if yes, the security processing system adjusts the clock division frequency factor and the output division frequency factor according to a fifth preset pattern, execute Step N2, otherwise execute Step N4.

Preferably, adjusting the clock division frequency factor and the output division frequency factor according to a fifth preset pattern specifically is that the security processing system obtains an original clock division frequency factor, deducts 1 from the original clock division frequency factor to obtain a new clock division frequency factor and sets the output division frequency factor to be a maximum value.

Step N4, the security processing system determines whether the count value of error filtering is qualified, if yes, adjust the count value of error filtering, the clock division frequency factor and the output division frequency factor according to a sixth preset pattern, execute Step N2, otherwise, return error message to the upper host.

Preferably, adjusting the count value of error filtering, the clock division frequency factor and the output division frequency factor according to the sixth preset pattern specifically is that the security processing system obtains an original count value of error filtering, deducts 1 from the original count value of error filtering and obtains a new count value of error filtering, sets the clock division frequency factor and the output division frequency factor to be the maximum value.

Preferably, the security processing system determines whether the count value of error filtering is qualified specifically is that the security processing system divides the self-damage wire output sampling frequency by the self-damage wire output sampling frequency to obtain a result and deducts 1 from the result to obtain a value and takes the value as cardinal number; when the modified count value of error filtering is more than the cardinal number, the count value of error filtering is not qualified; when the modified count value of error filtering is a non-zero number which less than or equal to the cardinal number, the count value of error filtering is qualified.

Specifically, when the self-damage wire is triggered in Step N2, the method specifically includes that the security processing system takes the values of parameters before adjusting as preset values of parameters, sets the anti-dismantle security setting identification and activates anti-dismantle and anti-detecting status.

It should be noted that in Embodiment 2 of the present invention, the dynamic signal can be random number, or a preset fixed number.

When the security processing system outputs dynamic signal via the self-damage wire output port, the security processing system can output dynamic signal according to a preset bytes, the security processing system can also output dynamic signal according to bits; after receiving signal via the self-damage wire input port, the security processing system can obtain preset bytes of signal according to the received signal; compares a plurality of sampling values corresponding to the preset bytes of signal with the preset bytes of dynamic signal output by the output port; the security processing system can also obtain preset bits of signal according to the received signal, compares a plurality of sampling values corresponding to the preset bits of signal with a preset bits of dynamic signal output by the output port.

In Embodiment 2, the instructions received by the security processing system further includes self-damage wire connect status detecting instruction, temperature triggering and detecting instruction, voltage detecting instruction, chip-level shield detecting instruction, lock function set-up instruction, and security monitoring detecting instruction.

When the instruction received by the security processing system is self-damage wire connect status detecting instruction, the following steps are executed:

Step 201, the secure processing system clears self-damage wire triggering warning status, obtains a self-damage wire triggering identification and stores the self-damage wire triggering identification, obtains times of triggering self-damage wire; and

Step 202, the security processing system determines whether self-damage wire triggering meets a third preset condition, if yes, execute Step 203; otherwise, execute Step 201.

Preferably, the security processing system determines whether self-damage wire triggering meets a third preset condition specifically is that the security processing system determines whether the times of triggering self-damage wire is more than or equal to a fifth preset value, when the times of triggering self-damage wire is more than or equal to a fifth preset value, the self-damage wire triggering meets a third preset condition; when the times of triggering self-damage wire is less than the fifth preset value, the times of triggering self-damage wire does not meet the third preset condition.

Specifically, the fifth preset value is 3.

Step 203, the security processing system obtains pathway flag bit when the self-damage wire is triggered each time, determines whether the pathway flag bits obtained when the self-damage wire is triggered each time are same, if yes, execute Step 204; otherwise, return error to the upper host.

Step 204, the security processing system determines whether a self-damage wire is not connected according to the pathway flag bit, if yes, return error to the upper host; otherwise, return a message that detecting self-damage wire connect status is completed.

In Embodiment 2, when security processing system receives the temperature triggering and detecting instruction, following step is executed: the security processing system determines whether current temperature meets a first preset condition, if yes, set a temperature triggering and detecting flag, return a message that temperature is triggered to the upper host; otherwise, return a message that temperature is not triggered to the upper host.

Preferably, the security processing system determines whether a current temperature meets a first preset condition specifically is that the security processing system determines whether a current temperature is higher than a first preset value or lower than a second preset value; when the temperature is equal to or lower than the first preset value and the temperature is higher than a second preset value, the current temperature is qualified; when the temperature is higher than the first preset value or lower than the second preset value, the temperature is not qualified.

Specifically, the first preset value is 125° C.; the second preset value is −50° C.

In Embodiment 2, when the security processing system receives voltage detecting instruction, the method includes: the security processing system determines whether a current voltage meets a second preset condition, if yes, set a voltage detecting flag, return a message that the voltage is not triggered to the upper host; otherwise, return a message that voltage is triggered to the upper host.

Specifically, the third preset value is 3.6V; the fourth preset value is 2.3V.

Preferably, that the security processing system determines whether a current voltage meets a second preset condition specifically is: the security processing system determines whether the current voltage is higher than a third preset value or lower than a fourth preset value; when the current voltage is equal to or lower than a third preset value and the current voltage is equal to and higher than a fourth preset value, the current voltage is qualified; when the current voltage is higher than the third preset value or is lower than a fourth preset value, the current voltage is not qualified.

In Embodiment 2, when the security processing system receives the chip-level shield instruction, the method includes: the security processing system determines whether a shield is triggered, if yes, the security processing system returns a message that the shield is triggered; if no, set a shield detecting flag and return a message that the shield is not triggered to the upper host.

In Embodiment 2, when the security processing system receives the lock function set-up instruction, the method includes: the security processing system checks whether lock function is normal, if yes, return a message that lock function is completed to the upper computer; otherwise, return an error message to the upper host.

In Embodiment 2, when the security processing system receives the security monitoring detecting instruction, the method includes: the security processing system checks whether internal and external security monitor function is normal, if yes, return a message that security monitor function is normal to the upper host; otherwise, return an error message to the upper host.

### Embodiment 3

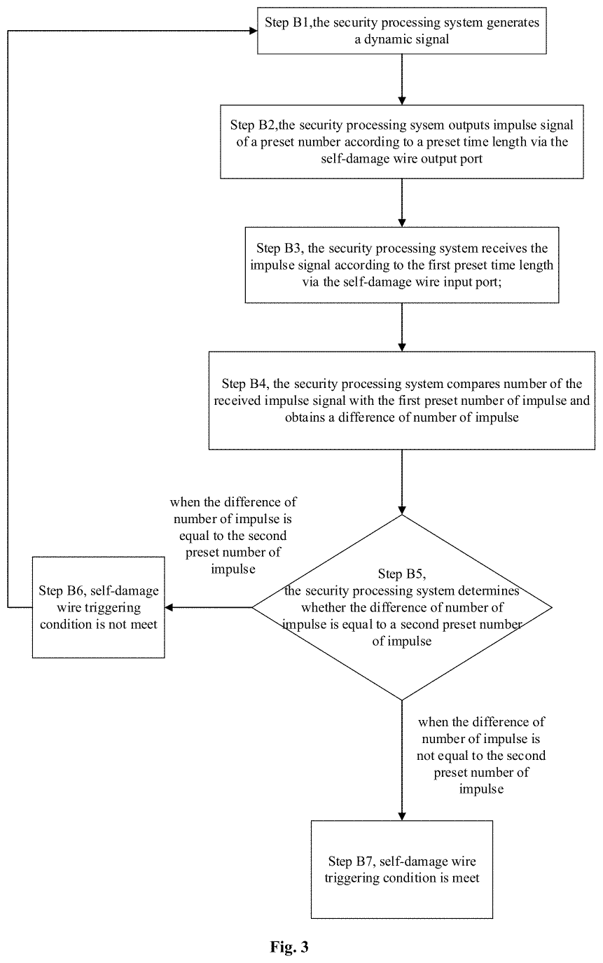

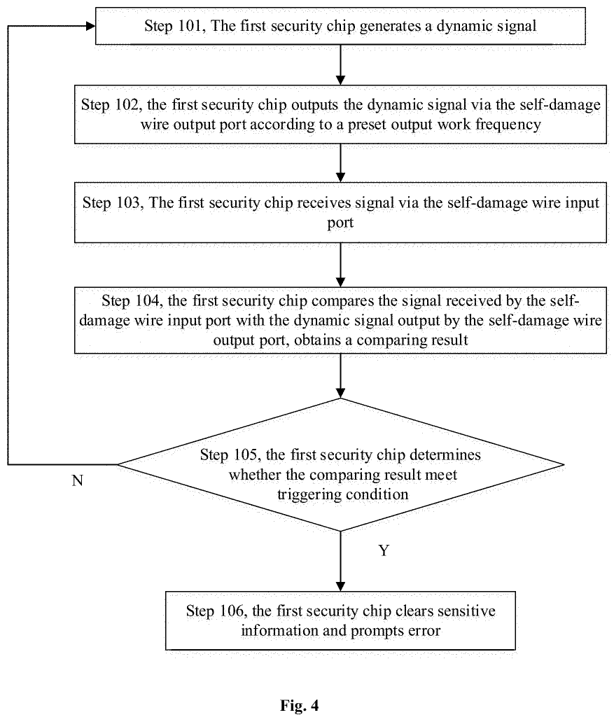

Embodiment 3 provides another specific embodiment of a detecting method for anti-dismantling terminal based on Embodiment 2; the terminal includes a security processing system, the security processing system includes a self-damage wire input port and a self-damage wire output port; the input port and the output port are connected via a self-damage wire; in this case, as shown by FIG. 3, the method includes:

Step B1, The security processing system generates a dynamic signal.

In Embodiment 3, the security processing system generates a dynamic signal which is impulse signal.

Step B2, the security processing system outputs impulse signal of a preset number according to a preset time length via the self-damage wire output port.

Step B3, the security processing system receives the impulse signal according to the first preset time length via the self-damage wire input port.

Step B4, the security processing system compares number of the received impulse signal with the first preset number of impulse and obtains a difference of number of impulses.

Step B5, the security processing system determines whether the difference of number of impulses is equal to a second preset number of impulses, when the difference of number of impulses is equal to the second preset number of impulses, execute Step B6; when the difference of number of impulse is not equal to the second preset number of impulse, execute Step B7.

Step B6, self-damage wire triggering condition is not meet, execute Step B1.

Step B7, self-damage wire triggering condition is meet, clear sensitive information.

In Embodiment 3, before Step B1, the method further includes:

Step C1, the security processing system receives a set-up instruction.

In Embodiment 3, Step C1 specifically includes: the security processing system waits for an upper host to issue an instruction, parses the instruction issued by the upper host, determines a type of the instruction, when the type of the instruction is set-up instruction, execute Step C2.

Step C2, the security processing system sets a first preset number of impulses, a first preset time length and a second preset number of impulses according to the set-up instruction.

Dynamic signal parameters of the security processing system include: the first preset number of impulses, the first preset time length; the self-damage wire triggering condition includes: the second preset number of impulses.

Step C3, the security processing system activates self-damage wire dynamic detecting function, execute Step B1.

In Embodiment 3, in Step B7, if the self-damage wire triggering condition is meet, the method further includes: the security processing system adjusts the number of the first preset impulse, the first preset time length and the second preset number of impulses.

Preferably, in Embodiment 3, the dynamic signal generated by the security processing system can be preset with initial phase pattern and output by the self-damage wire output port.

That the security processing system compares the signal received by the self-damage wire input port with the dynamic signal output by the self-damage wire output port and obtains a comparing result is that the security processing system compares phase pattern of the output dynamic signal with the phase pattern of the signal received by the self-damage wire input port to obtain a change value of phase pattern.

Preferably, in Embodiment 3, the self-damage wire triggering condition can be a phase pattern change threshold value.

Specifically, that the security processing system determines whether the comparing result meets self-damage wire triggering condition specifically is: the security processing system determines whether the phase pattern change value is more than the phase pattern change threshold, when the phase pattern change value is less than or equal to the phase pattern change threshold, the self-damage wire condition is not meet; when the phase pattern change value is more than the phase pattern change threshold, the self-damage wire condition is meet.

Preferably, when the security processing system receives a set-up instruction, the method further includes that the security processing system sets an initial phase pattern according to the set-up instruction; the self-damage wire condition includes a phase pattern change value.

Preferably, in Embodiment 3, after the security processing system determines that the phase pattern change value meets the self-damage wire triggering condition further includes that the security processing system adjusts the phase pattern change threshold.

### Embodiment 4

Embodiment 4 provides another specific embodiment of a detecting method for anti-dismantling terminal; the terminal includes a security processing system, the security processing system includes a first security chip, the first security chip includes a self-damage wire input port and a self-damage wire output port, the self-damage wire input port and the self-damage wire output port are connected via a self-damage wire; as shown by FIG. 4, the detecting method includes:

Step 101, the first security chip generates a dynamic signal.

In Embodiment 4, the dynamic signal generated by the first security chip can be random number signal or fixed number signal.

When the dynamic signal is random number, that the first security chip generates a dynamic signal specifically is: the first security chip generates random numbers consecutively by invoking a random number generating function and stores the random numbers in the first security chip.

Step 102, the first security chip outputs the dynamic signal via the self-damage wire output port according to a preset output work frequency.

In Embodiment 4, when the dynamic signal is random number, the first security chip outputs the dynamic signal via the self-damage wire output port according to a preset output work frequency specifically is: the first security chip obtains random numbers of a preset length, converts the random numbers of the preset length into a first digital signal, outputs the first digital signal via the self-damage wire output port according to the preset output work frequency.

Specifically, the preset length is one byte.

Step 103, the first security chip receives signal via the self-damage wire input port. In Embodiment 4, specifically, the first security chip receives signal via the self-damage wire input port and samples the received signal according to a preset sampling frequency to obtain a plurality of sampling values.

Step 104, the first security chip compares the signal received by the self-damage wire input port with the dynamic signal output by the self-damage wire output port, obtains a comparing result.

In Embodiment 4, specifically, the first security chip compares the value of the dynamic signal with the plurality of sampling value one by one to obtain a times of error sampling values.

Step 105, the first security chip determines whether the comparing result meet triggering condition, if yes, execute Step 106; otherwise, execute Step 101.

In Embodiment 4, specifically, that the first security chip determines whether the comparing result meets the triggering condition specifically is: the first security chip determines whether the times of the error sampling values is more than a preset value, if yes, the triggering condition is meet; otherwise, the triggering condition is not meet.

The preset value is error filtering count value.

Step 106, the first security chip clears sensitive information and prompts error.

### Embodiment 5

Embodiment 5 provides a device for terminal anti-mantling, the device includes a security processing module, the security processing module includes a self-damage wire input port and a self-damage wire output port.

The security processing module is configured to generate a dynamic signal, output dynamic signal via the self-damage wire output port, receive signal via the self-damage wire input port; compare the signal received by the self-damage wire input port and the dynamic signal output by the self-damage wire output port and obtain a comparing result; determine whether the comparing result meets a self-damage wire triggering condition, if yes, determine that the self-damage wire is triggered; otherwise, determine that the self-damage wire is not triggered.

In Embodiment 5, preferably, the security processing module further is configured to receive setting instruction, a set-up instruction, set a dynamic signal parameter and the self-damage wire triggering condition according to the set-up instruction; and

the security processing module is further configured to output the dynamic signal via the self-damage wire output port according to the dynamic signal parameter and receiving signal via the self-damage wire input port according to the dynamic signal parameter.

Preferably, the security processing module is further configured to receive a set-up instruction, activate a self-damage wire dynamic detecting function and adjust the dynamic signal parameter and the self-damage wire triggering condition according to the triggering result.

Preferably, in Embodiment 5, the dynamic signal parameter specifically comprises an output frequency, sampling frequency.

When the security processing module is configured to output dynamic signal via the self-damage wire output port according to dynamic signal parameter, specifically is configured to output dynamic signal via the self-damage wire output port according to the output frequency and receive signal via the self-damage wire input port according to the sampling frequency when receiving signal via the self-damage wire input port according to the dynamic signal parameter.

The security processing module is configured to compare the signal received by the self-damage wire input port with the dynamic signal output by the self-damage wire output port to obtain a comparing result specifically is: the security processing module is configured to sample the signal received by the self-damage wire input port according to a preset input sampling frequency to obtain a plurality of sampling values, compare the plurality sampling values with a value of the output dynamic signal and obtain times of error sampling value.

Specifically, in Embodiment 5, the self-damage wire triggering condition specifically is a count value of error filtering.

That the security processing module is configured to determine whether a comparing result meets a self-damage wire triggering condition specifically is that the security processing module is configured to determine whether the times of error sampling value is more than the count value of error filtering; when the times of error sampling value is more than the count value of error filtering, the self-damage wire triggering condition is meet; when the times of error sampling value is less than or equal to the count value of error filtering, the self-damage wire triggering condition is not meet.

The security processing module is further configured to detect a self-damage wire dynamic detecting function, obtain a self-damage wire triggering result according to the times of error sampling values and the counter value of error filtering, adjust the output frequency, the sampling frequency and the counter value of filtering according to the triggering result.

Preferably, in Embodiment 5, the dynamic signal parameters specifically include: a first preset pulse number and a first preset time length.

That the security processing module is configured to output the dynamic signal via the self-damage wire output port according to the dynamic signal parameter and receive signal via the self-damage wire input port according to the dynamic signal parameter is specifically: that the security processing module is configured to output the first preset pulse number via the self-damage wire output port according to the first preset time length and receive pulse signal via the self-damage wire input port according to the first preset time length.

That the security processing module is configured to compare the signal received by the self-damage input port with the dynamic signal output by the self-damage wire output port to obtain a comparing result specifically is that the security processing module is configured to compare the first preset impulse number of the output dynamic signal and the number of the impulse signal received by the self-damage wire input port to obtain a difference of impulse number.

Specifically, in Embodiment 5, the self-damage wire triggering condition specifically is a second preset impulse number.

That the security processing module is configured to determine whether a comparing result meets a self-damage wire triggering condition specifically is that the security processing module is configured to determine whether the difference of impulse number is equal to the second preset impulse number, when the difference of the impulse number is equal to the second preset impulse number, the self-damage wire triggering condition is not meet; when the difference of the impulse number is not equal to the second preset impulse number, the self-damage wire condition is meet.

The security processing module is further configured to activate self-damage wire dynamic detecting function, obtain the self-damage wire triggering result according to the difference of the impulse number and the second preset impulse number, adjust the first preset impulse number, the second preset impulse number and the first preset time length according to the triggering result.

Preferably, in Embodiment 5, the dynamic signal parameter specifically is a preset initial phase pattern.

That the security processing module is configured to output the dynamic signal via the self-damage wire output port according to the dynamic signal parameter and receive signal via the self-damage wire input port according to the dynamic signal parameter specifically is that the security processing module is configured to output the dynamic signal via the self-damage wire output port according to the preset initial phase pattern and receive dynamic signal via the self-damage wire input port.

That the security processing module is configured to compare the signal received by the self-damage wire input port with the dynamic signal output by the self-damage wire output port and obtain a comparing result specifically is that the security processing module is configured to compare phase pattern of the output dynamic signal with the phase pattern of the signal received by the self-damage wire input port to obtain a change value of phase pattern.

Specifically, in Embodiment 5, the self-damage wire triggering condition specifically is a phase pattern change threshold value.

That the security processing module is configured to determine whether the comparing result meets self-damage wire triggering condition specifically is that the security processing module is configured to determine whether the phase pattern change value is more than the phase pattern change threshold, when the phase pattern change value is less than or equal to the phase pattern change threshold, the self-damage wire condition is not meet; when the phase pattern change value is more than the phase pattern change threshold, the self-damage wire condition is meet.

The security processing module is further configured to activate self-damage wire dynamic detecting function, obtain the self-damage wire triggering result according to the phase pattern change value and the phase pattern change threshold value, adjust the phase pattern change threshold value according to the triggering result.

Preferably, in Embodiment 5, the security processing module is further configured to clear any sensitive information.

Preferably, that the security processing module is configured to generate dynamic signal is that the security processing module is specifically configured to invoke a random number generating function to generate random number consecutively and storing the random numbers in the security processing system.

Preferably, the security processing module comprises a first security chip, the self-damage wire output port and the self-damage wire input port are located on the first security chip.

The first security chip is configured to generate the dynamic signal, output the generated dynamic signal via the self-damage wire output port and receive signal via the self-damage wire input port; compare the output dynamic signal with the received signal and obtain a comparing result; and determine whether the comparing result meets a triggering condition, if yes, self-damage wire is triggered; if no, self-damage wire is not triggered.

Preferably, the security processing module comprises a first master control chip and a second security chip; the self-damage wire output port and the self-damage wire input port are located on the second security chip;

the first master control chip is configured to generate the dynamic signal and send the generated dynamic signal to the second security chip;

the second security chip is configured to output the dynamic signal via the self-damage wire output port, receive the signal via the self-damage wire input port; compare the output dynamic signal with the received signal and obtain a comparing result; determine whether the comparing result meets a triggering condition, if yes, determine that the self-damage wire is triggered; otherwise, determine that the self-damage wire is not triggered.

Preferably, the security processing module comprises a third security chip and a fourth security chip, the self-damage wire output port is located on the third security chip, the self-damage wire input port is located on the fourth security chip;

the third security chip is configured to generate dynamic signal and output dynamic signal via the self-damage wire output port; and

the fourth security chip is configured to receive signal via the self-damage wire input port.

Preferably, the fourth security chip is further configured to send the received signal to the third security chip; and

the third security chip is further configured to compare the output dynamic signal with the received signal.

Preferably, the third security chip is further configured to send the dynamic signal to the fourth security chip; and

the fourth security chip is further configured to compare the received dynamic signal with the signal receive via the self-damage wire input port.

Preferably, the third security chip is further configured to generate dynamic signal, converts the dynamic signal and output the converted signal via the self-damage wire output port; and

the fourth security chip is further configured to receive signal via the self-damage wire input port.

Preferably, the third security chip is further configured to send the dynamic signal and a converting algorithm to the fourth security chip; and

the fourth security chip is further configured to convert the dynamic signal received according to the converting algorithm and obtain converted signal, compare the signal received by the self-damage wire input port with the converted signal.

Preferably, the security processing module includes a second master control chip, a fifth security chip and a sixth security chip; the self-damage wire output port is located on the fifth security chip, the self-damage wire input port is located on the sixth security chip;

the second master control chip is configured to generate a dynamic signal and send the dynamic signal to the fifth security chip;

the fifth security chip is configured to output dynamic signal via the self-damage wire output port; and

the sixth security chip is configured to receive signal via the self-damage wire input port.

Preferably, the sixth security chip is further configured to send the received signal to the second master control chip; and

the second master control chip is further configured to compare the received signal with the generated dynamic signal.

Preferably, the second master control chip is further configured to send the dynamic signal to the sixth security chip; and

the sixth security chip is further configured to compare the received dynamic signal with the signal received via the self-damage wire input port.

Preferably, the second master control chip is further configured to generate dynamic signal, convert the dynamic signal and send the converted dynamic signal to the fifth security chip;

the fifth security chip is further configured to output the converted dynamic signal via the self-damage wire output port; and

the sixth security chip is further configured to receive signal via the self-damage wire input port

Preferably, the sixth security chip is further configured to send the received signal to the second master control chip; and the second master control chip is further configured to compare the received signal and the converted dynamic signal.

Preferably, the second master control chip is further configured to send the dynamic signal and a converting algorithm to the sixth security chip; and

the sixth security chip is further configured to convert the received dynamic signal according to the converting algorithm, compare the signal received via the self-damage wire input port and the converted signal.

The present invention provides a detecting method for anti-dismantling terminal and a device therefor. By means of multiple anti-dismantle technologies, such as temperature, voltage, chip level shield and dynamic MESH wire, the present invention assures that any sensitive information can be destroyed right away when a protected product is illegally dismantled or attacked from outside and guarantees that any personal sensitive information will not be leaked.

Details of embodiments of the detecting method for anti-dismantling terminal and a device therefor are introduced by the present invention. The descriptions above are only specific embodiments of the present disclosure, but the protection scope of the present disclosure is not limited to this, and any changes or replacements that can be easily thought of within the technical scope disclosed by the present disclosure by those skilled in the art shall fall within the protection scope of the present disclosure. Therefore, the scope of protection of the present disclosure shall be subject to the protection scope of the claims.

1. A method for detecting a terminal for protecting it from being dismantled, wherein the terminal comprises a security processing system, and the security processing system comprises a self-damage wire input port and a self-damage wire output port; the method comprises the following steps:
S1) generating, by the security processing system, a dynamic signal, outputting the dynamic signal via the self-damage wire output port, and receiving a signal via the self-damage wire input port;
S2) comparing, by the security processing system, the signal received by the self-damage wire input port with the dynamic signal output by the self-damage wire output port, and obtaining a comparing result; and
S3) determining, by the security processing system, whether the comparing result meets a self-damage triggering condition, if yes, a self-damage wire is triggered; if no, the self-damage wire is not triggered.

2. The method of claim 1, wherein, before the security processing system generates the dynamic signal, the method further comprises: receiving, by the security processing system, a set-up instruction, and setting a dynamic signal parameter and the self-damage triggering condition according to the setting up instruction;
outputting the dynamic signal via the self-damage wire output port and receiving a signal via the self-damage wire input port specifically is outputting the dynamic signal via the self-damage wire output port according to the dynamic signal parameter, and receiving the signal via the self-damage wire input port according to the dynamic signal parameter.

3. The method of claim 2, wherein after setting a dynamic signal parameter and a self-damage wire triggering condition by the security processing system, the method further comprises: activating, by the security processing system, a self-damage wire dynamic detecting function, executing Step S1 to Step S3, thus adjusting the dynamic signal parameter and the self-damage triggering condition according to a triggering result of Step S3.

4. The method of claim 2, wherein setting, by the security processing system, a dynamic signal parameter specifically comprises a first preset pulse number and a first preset time length;
outputting the dynamic signal via the self-damage wire output port according to the dynamic signal parameter and receiving the signal via the self-damage wire input port according to the dynamic signal parameter specifically are that outputting, by the security processing system, the first preset pulse number via the self-damage wire output port according to the first preset time length, and receiving a pulse signal via the self-damage wire input port according to the first preset time length.

5. The method of claim 2, wherein setting, by the security processing system, the dynamic signal parameter specifically is presetting an initial phase pattern,
outputting the dynamic signal via the self-damage wire output port according to the dynamic signal parameter and receiving the signal via the self-damage wire input port according to the dynamic signal parameter specifically are outputting, by the security processing system, the dynamic signal via the self-damage wire output port according to the preset initial phase pattern and receiving signal via the self-damage wire input port.

6. The method of claim 1, wherein after the self-damage wire is triggered, the method further comprises that the security processing system clears any sensitive information.

7. The method of claim 1, wherein generating, by the security system, the dynamic signal specifically is: invoking, by the security processing system, a random number generating function to generate random numbers consecutively, and storing the random numbers in the security processing system.

8. The method of claim 1, wherein the security processing system comprises a first security chip, the self-damage wire output port and the self-damage wire input port are located on the first security chip; the method specifically comprises:
generating, by the first security chip, the dynamic signal, outputting the generated dynamic signal via the self-damage wire output port and receiving the signal via the self-damage wire input port;
comparing, by the first security chip, the output dynamic signal with the received signal, and obtaining a comparing result; and
determining, by the first security chip, whether the comparing result meets a triggering condition, if yes, a self-damage wire is triggered; if no, the self-damage wire is not triggered.

9. The method of claim 1, wherein the security processing system comprises a first master control chip and a second security chip; the method specifically comprises:
generating, by the first master control chip, the dynamic signal and sending the generated dynamic signal to the second security chip;
outputting, by the second security chip, the dynamic signal via the self-damage wire output port, receiving, by the second security chip, the signal via the self-damage wire input port;
comparing, by the second security chip, the output dynamic signal and the received signal, and obtaining a comparing result; and
determining, by the second security chip, whether the comparing result meets a triggering condition, if yes, a self-damage wire is triggered; if no, the self-damage wire is not triggered.

10. The method of claim 1, where the security processing system comprises a third security chip and a fourth security chip, the self-damage wire output port is located on a third security chip, and the self-damage wire input port is located on a fourth security chip;
generating, by the security processing system, a dynamic signal, outputting the dynamic signal via the self-damage wire output port, and receiving the signal via the self-damage wire input port specifically are:
generating, by the third security chip, the dynamic signal, outputting the dynamic signal via the self-damage wire output port, and receiving, by the fourth security chip, the signal via the self-damage wire input port.

11. The method of claim 1, wherein the security processing system comprises a second master control chip, a fifth security chip and a sixth security chip; the self-damage wire output port is located on the fifth security chip, the self-damage wire input port is located on the sixth security chip;
generating, by the security processing system, a dynamic signal, outputting the dynamic signal via the self-damage wire output port, and receiving the signal via the self-damage wire input port specifically are:
generating, by the second master control chip, the dynamic signal, sending the dynamic signal to the fifth security chip; outputting, by the fifth security chip, the dynamic signal via the self-damage wire output port; receiving, by the sixth security chip, the signal via the self-damage wire input port.

12. A device for detecting an anti-dismantling terminal, wherein the device comprises a security processing module, the security processing module comprises a self-damage wire output port and self-damage wire output port;
the security processing module is configured to generate a dynamic signal, output the dynamic signal via the self-damage wire output port, receive a signal via the self-damage wire input port; compare the signal received by the self-damage wire input port and the dynamic signal output by the self-damage wire output port and obtain a comparing result; determine whether the comparing result meets a self-damage wire triggering condition, if yes, determining that a self-damage wire is triggered; otherwise, determining that the self-damage wire is not triggered.

13. The device of claim 12, wherein the security processing module is further configured to receive a set-up instruction, set a dynamic signal parameter and the self-damage wire triggering condition according to the set-up instruction; and
the security processing module is further configured to output the dynamic signal via the self-damage wire output port according to the dynamic signal parameter and receiving signal via the self-damage wire input port according to the dynamic signal parameter.

14. The device of claim 13, wherein the security processing module is further configured to receive a set-up instruction, activate a self-damage wire dynamic detecting function and adjust the dynamic signal parameter and the self-damage wire triggering condition according to the triggering result.

15. The device of claim 13, wherein the dynamic signal parameter specifically comprises a first preset pulse number and a first preset time length;
that the security processing module is configured to output the dynamic signal via the self-damage wire output port according to the dynamic signal parameter and receive the signal via the self-damage wire input port according to the dynamic signal parameter are specifically that the security processing module is configured to output the first preset pulse number via the self-damage wire output port according to the first preset time length and receive a pulse signal via the self-damage wire input port according to the first preset time length.

16. The device of claim 13, wherein the dynamic signal parameter specifically is a preset initial phase pattern;
that the security processing module is configured to output the dynamic signal via the self-damage wire output port according to the dynamic signal parameter and receive the signal via the self-damage wire input port according to the dynamic signal parameter specifically are that the security processing module is configured to output the dynamic signal via the self-damage wire output port according to the preset initial phase pattern and receive dynamic signal via the self-damage wire input port.

17. The device of claim 12, wherein the security processing module is further configured to clear any sensitive information.

18. The device of claim 12, wherein that the security processing module is configured to generate dynamic signal specifically is that the security processing module is configured to invoke a random number generating function to generate random numbers consecutively, and storing the random numbers in the security processing system.

19. The device of claim 12, wherein the security processing module comprises a first security chip, the self-damage wire output port and the self-damage wire input port are located on the first security chip;
the first security chip is configured to generate the dynamic signal, output the generated dynamic signal via the self-damage wire output port and receive the signal via the self-damage wire input port; compare the output dynamic signal with the received signal and obtain a comparing result; and determine whether the comparing result meets a triggering condition, if yes, a self-damage wire is triggered; if no, the self-damage wire is not triggered.

20. The device of claim 12, wherein the security processing module comprises a first master control chip and a second security chip; the self-damage wire output port and the self-damage wire input port are located on the second security chip;
the first master control chip is configured to generate the dynamic signal and send the generated dynamic signal to the second security chip;
the second security chip is configured to output the dynamic signal via the self-damage wire output port, and receive the signal via the self-damage wire input port; compare the output dynamic signal with the received signal and obtain a comparing result; determine whether the comparing result meets a triggering condition, if yes, determine that the self-damage wire is triggered; otherwise, determine that the self-damage wire is not triggered; or
the security processing module comprises a third security chip and a fourth security chip, the self-damage wire output port is located on the third security chip, and the self-damage wire input port is located on the fourth security chip;
the third security chip is configured to generate the dynamic signal and output the dynamic signal via the self-damage wire output port;
the fourth security chip is configured to receive the signal via the self-damage wire input port; or
the security processing module comprises a second master control chip, a fifth security chip and a sixth security chip; the self-damage wire output port is located on the fifth security chip; and the self-damage wire input port is located on the sixth security chip;
the second master control chip is configured to generate a dynamic signal and send the dynamic signal to the fifth security chip;
the fifth security chip is configured to output the dynamic signal via the self-damage wire output port;
the sixth security chip is configured to receive the signal via the self-damage wire input port.
